(19) United States
(12) Patent Application Publication
(10) Pub. No.: US 2007/0274066 A1
(43) Pub. Date: Nov. 29, 2007

(54) Lantern using LEDs and rechargeable solar panel

(75) Inventors: Pervaiz Lodhie, Rolling Hills, CA (US); Lei U. Vinoya, Carson, CA (US); Emery A. Brown, Tujunga, CA (US)

Correspondence Address: IRVING KESCHNER, 21535 HAWTHORNE BOULEVARD, SUITE 385, TORRANCE, CA, 90503, US

(73) Assignee: Ledtronics, Inc.

(21) Appl. No.: 11/440,805

(22) Filed: May 25, 2006

(51) Int. Cl. F21L 4/00

(52) U.S. Cl. 362/183

(57) ABSTRACT

A solar rechargeable lantern that utilizes light emitting diodes (LEDs) as the light source. The lantern comprises a base member having a rechargeable battery positioned therein, a light emitting portion, a solar panel connected to the battery and a printed circuit board mounted in the light emitting portion and having a plurality of LED arrays mounted thereto, the battery in turn being connected to the LED arrays. A controller is provided to control the charge applied to the battery by the solar panel and to monitor the charge status of the battery. The LED array comprises twelve parallel rows of LEDs, each row having a plurality of serially connected LEDs.

### BACKGROUND OF THE INVENTION

1. Field of the Invention

The present invention relates to a solar rechargeable lantern using LEDs for illumination.

2. Description of the Prior Art

Battery powered lanterns are well known in the prior art and are used as portable light sources for a wide variety of work and leisure activities. Such lanterns typically include a base and a fixture mounted on the base. One or more incandescent light bulbs are supported within the fixture, and a battery is contained within the base to power the bulbs.

Solar-powered lanterns were developed to eliminate the need to replace conventional batteries prematurely and/or the need to carry extra batteries. These solar-powered lanterns include a rechargeable battery in the base and a separate solar panel that can be connected to the lantern to recharge the battery. Unfortunately, solar-powered lanterns suffer several disadvantages. First, when the battery fully discharges, the life of the battery is shortened. Second, full discharge degrades the battery, causing the battery to hold less charge each cycle. Third, the lights within the solar lanterns oscillate or flicker when the battery is weak.

The problems noted hereinabove were addressed in U.S. Pat. No. 6,290,367 to Greenhoe et al wherein a power management system is utilized in a solar-powered rechargeable lantern to prevent the battery from fully discharging and to prevent the lantern from operating when the battery is charging.

Although the '367 patent addressed the battery problems in a solar rechargeable lantern, the standard problems of using conventional incandescent bulbs as the illumination source still remain. While the technology underlying the use of incandescent lights is familiar, there are a number of shortcomings that make their use less than ideal. For example, the incandescent light sources adapted for use in a solar rechargeable lantern typically have a short life expectancy. Thereafter, the light sources must be replaced, thereby incurring maintenance costs related to labor, replacement parts, and inventory overhead and storage.

In addition, incandescent light sources emit white or polychromatic light. As such, to achieve a different color, specifically designed colored lenses are needed to filter the polychromatic light to the required chromaticity or color quality. Thus, wasted power is expended in the emission of unusable light, which consequently increases the probability of heat damage to the surrounding components and housing structure.

What is desired is to provide a solar rechargeable lantern that incorporates a light source that overcomes one or more of the aforementioned shortcomings.

### SUMMARY OF THE INVENTION

The present invention provides a solar rechargeable lantern that utilizes light emitting diodes (LEDs) as the light source. A light-emitting diode (LED) is a diode that emits light when a current passes through it. A diode is a semiconductor device through which current can pass in only one direction. LEDs are more efficient, last longer, and are more durable than incandescent lamps and are approximately 16 times more efficient at producing light than incandescent lamps. While an incandescent lamp may produce light for 750 to 2,000 operating hours, of continuous use, many LEDs can produce light for 100,000 hours of continuous use. The lantern comprises a base member having a rechargeable battery positioned therein, a solar panel for charging the battery when necessary and a printed circuit board mounted in the base member having a plurality of LED arrays mounted thereon, the battery in turn being connected to the LED arrays. When the lantern is switched on, the user can select low or high illumination as required. In the preferred embodiment, the LED array comprises twelve parallel rows of LEDs, each row having two LEDs.

A charge controller is provided to regulate the voltage from the solar panel during battery charge and to monitor the battery charge during operation, a first LED indicating when the battery charge is normal and a second LED indicating when the battery needs to be charged.

The present invention thus provides a solar rechargeable lantern that is less costly to maintain than lanterns currently available by using LEDs as the light source.

### DESCRIPTION OF THE DRAWINGS

For a better understanding of the present invention as well as other objects and further features thereof, reference is made to the following description which is to be read in conjunction with the accompanying drawing therein:

FIG. 1 is a front plan view of the solar rechargeable LED lantern of the present invention;

FIG. 2 is a side plan view of the lantern of FIG. 1;

FIG. 3 is a bottom view of the lantern of FIG. 1;

FIG. 4 is a cross-sectional view along line 4-4 of FIG. 1;

FIG. 5 is a cross-sectional view along line 5-5 of FIG. 4;

FIG. 6 is a cross-sectional view along line 6-6 of FIG. 1;

FIG. 7 is a cross-sectional view along line 7-7 of FIG. 6;

FIG. 8 is a cross-sectional view along line 8-8 of FIG. 6; and

FIG. 9 is the wiring diagram utilized in the solar lantern of the present invention.

### DESCRIPTION OF THE INVENTION

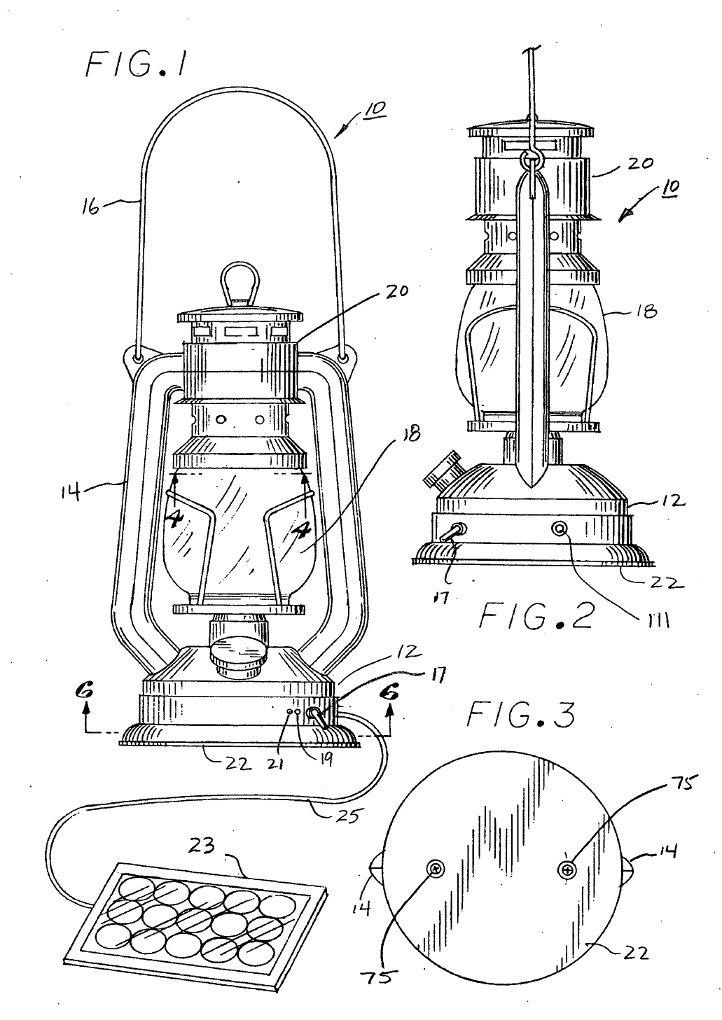

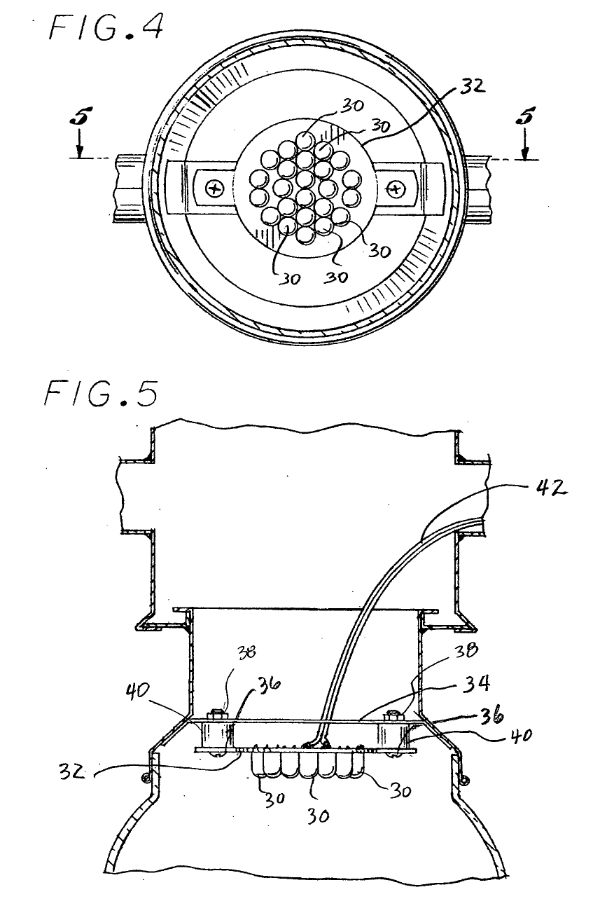

Referring new to FIGS. 1-3, the modified solar lantern 10 of the present invention is illustrated. Lantern 10 comprises a base portion 12, support structure 14, handle 16, switch 17, transparent envelope 18, and cover portion 20 and bottom surface 22. In addition, solar panel 23 is coupled to base portion 12 via lead 25 when the lantern battery is to be recharged. Although not shown in FIG. 2, lead 25 enters base portion 12 through connector/switch 111. Lantern 10 is conventional except for the modifications set forth in FIGS. 4-9 as will now be described. In particular, FIGS. 4 and 5 illustrate a plurality of light emitting diodes (LEDs) 30 supported on printed circuit board (PCB) 32. PCB 32 in turn is mounted to base plate 34 via screws 36 and nuts 38. Spacers 40 separate PCB 32 from plate 34. Cable 42 couples the power from battery pack 60 (FIG. 9) to the PCB 32 which, in turn, provides power to the LEDs 30.

When lantern 10 is ready for use, switch 17 is moved either to the upper (high light) or lower (low light) position depending upon user light requirements (the switch center position turns lantern 10 off). During normal lantern operation (either the high or low light modes), green LED light 19 is illuminated, battery pack 60 having a normal charge as power is supplied to the LEDs 30. When light 19 goes off and LED light 21 goes on, battery pack 60 must be recharged. In order to recharge battery pack 60, solar panel 23 is positioned on a flat surface in direct sunlight. Solar panel cord 25 is coupled to lantern 10 (and to battery pack 60 via circuitry to be described) through opening 27 with switch 17 placed in any position, red LED 23 turning on. When battery pack 60 is fully charged, green LED light 21 goes on, indicating that lantern 10 is ready for use.

The LEDs 30 selected generate white light when energized although LEDs generating light of other colors may be selected for use.

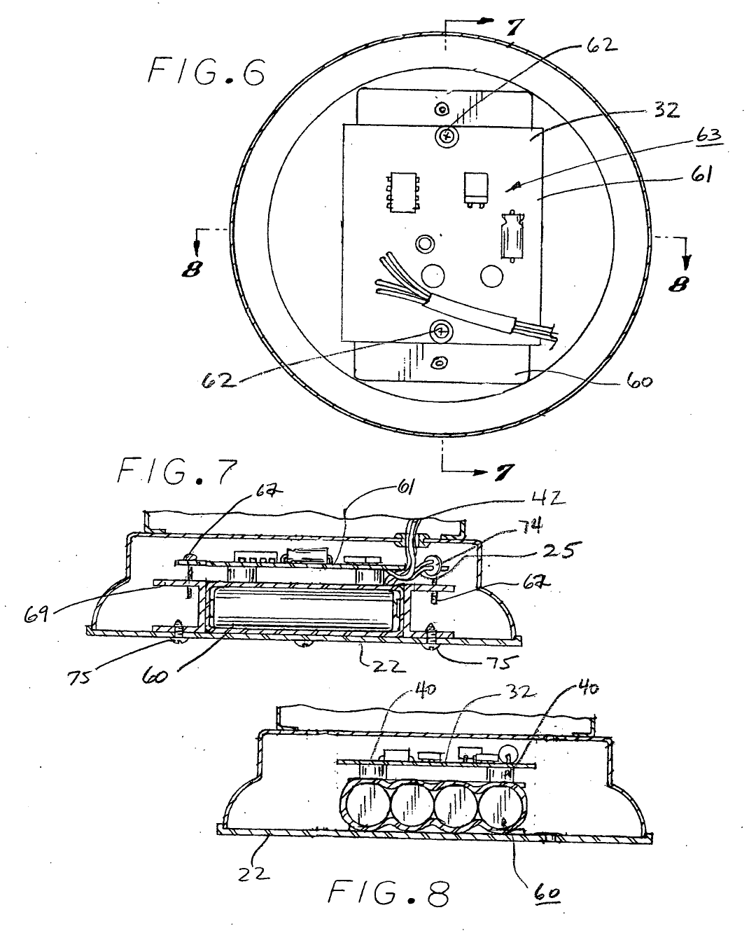

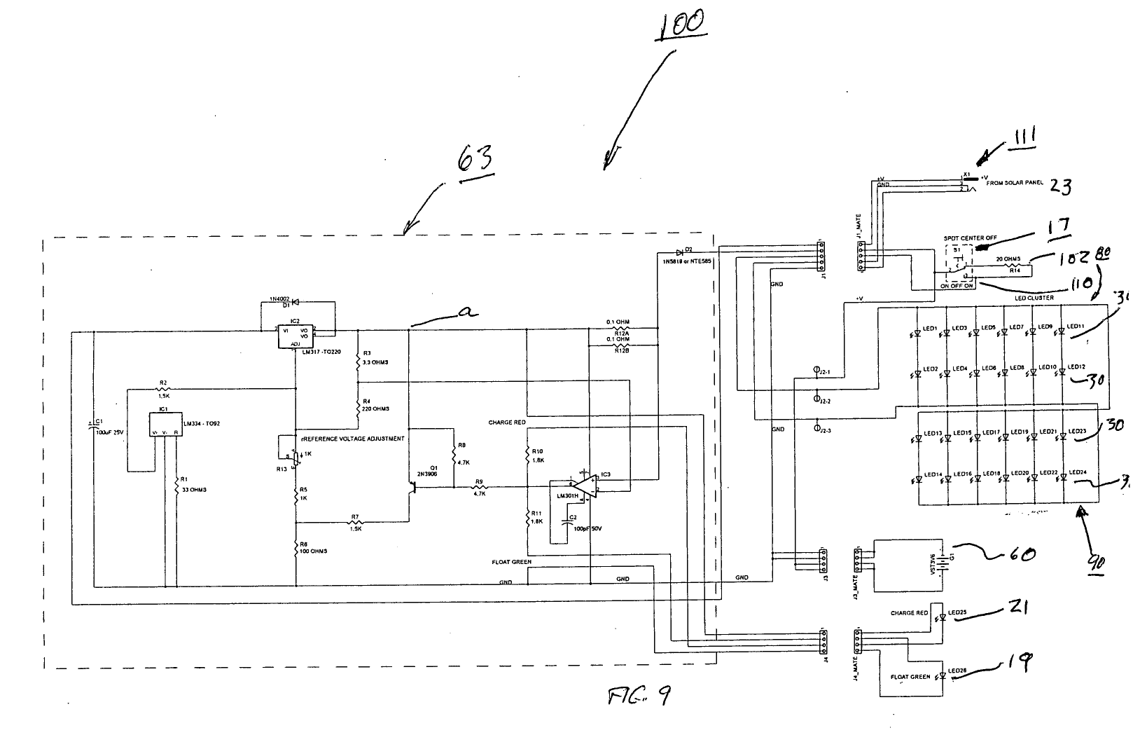

FIG. 6 is a view illustrating printed circuit board 61 for charge controller 63 and battery pack 60. Screws 62 fasten circuit board 61 to the frame 69 enclosing battery pack 60. Wires 42 couple battery pack 60 to LEDs 30. FIG. 7 further illustrates wires 25 from solar panel 23 and screws 75 for fastening battery pack 60 to lantern base plate 22. FIG. 8 shows how base plate 22 is mounted to lantern 10. As will be explained in more detail with reference to FIG. 9, charge controller 63 regulates the voltage and current coming from solar panel 23 to battery pack 60 since the typical solar panel configuration produces more voltage than necessary to charge the battery. In addition, charge controller 63 also monitors the battery charge during normal operation and provides an indication via LED 21 that the battery charge is normal and via LED 23 when the battery charge needs to be replenished.

FIG. 9 is a schematic illustrating the operation of the solar lantern 10 of the present invention.

Circuit 100 operates in two basic modes. The description that follows will initially discuss the first operating mode wherein solar panel 23 is not connected to the solar lantern 10; thereafter, the description will discuss the second operating mode when solar panel 23 is connected to the lantern 10.

In the first mode, battery pack 60 is coupled to the LED arrays 80 and 90 via charge controller 63 and switch 17. With switch 17 in the position shown (the low light intensity position) battery pack 60 is connected through resistor 102 and thence to the LED arrays 80 and 90. The output of the battery pack 60 is also coupled to charge controller 63 whereby the charge on the battery pack 60 is monitored. During this time period, current is supplied to LED 21 such that the light (green) is illuminated. When the switch 17 is flipped such that contact arms are coupled to switch contact 110, the lantern 10 is in the higher intensity lighting mode since resistor 102 is no longer in the circuit path thus increasing the current flowing through arrays 80 and 90, the light intensity from each of the LEDs 30 making up each array thus being increased

In the second mode of operation, solar panel 23 is connected to the lantern 10 via connector/switch 111 which breaks the connection between switch 17 and the LED arrays 80 and 90, the LEDs 30 not providing illumination during this mode. In addition, solar panel 23 is coupled to charge controller 63 whereby the variable output from the solar panel can be monitored and controlled before it is utilized to charge battery pack 60. At this time, LED 21 is energized and produces red light indicating that battery pack 60 is being charged. It should be noted that LED 21 is also illuminated when the charge on the battery is below a predetermined value.

Component IC2 is a voltage regulator and monitors voltage output from solar panel 23 to ensure that battery pack 60 is not overcharged. Operational amplifier IC3 detects charge at point a, amplifies it and compares it with the desired output charge from battery pack 60; if it is below the predetermined value, LED 21 is energized; if at or above the desired value, LED 19 is energized.

When battery pack 60 is fully charged and lantern 10 is operational, power is supplied to LEDs 30 through IC2. LM 334 is a current regulator and provides a reference voltage for adjusting IC2. Resistors R5 and R6 also adjust the reference voltage supplied to IC2. The output from battery pack 60 is feedback to charge controller 63 through transistor Q1 causing the reference voltage at point a to vary. Diode D2 does not allow the charge controller circuitry 63 to drain power from battery pack 63 when voltage from solar panel 23 drops below the voltage of battery pack 60.

As illustrated, each array 80 and 90 comprises a total of twenty four LEDs 30 connected as twelve parallel arms of two serially connected LEDs. Arrays 80 and 90, in turn, are connected in parallel.

The present invention thus provides an improved solar panel rechargeable lantern wherein LEDs are utilized to provide illumination providing a more efficient light source with a longer life expectancy.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A solar lantern comprising:
a plurality of LEDs;
a battery for providing power to said LEDs;
a solar panel;
means for releasably connecting said solar panel to said battery; and
a controller for controlling the charge applied by said solar panel to said battery and for monitoring the charge status of said battery.

2. The solar lantern of claim 1 wherein said lantern comprises a base, an upper portion and a light emitting portion positioned between said upper portion and said base, a printed circuit board having said LEDs mounted thereon being positioned within said light emitting portion.

3. The solar lantern of claim 2 wherein said LEDs generate white light when power is applied thereto from said battery.

4. The solar lantern of claim 2 wherein said LEDs are arranged in twelve parallel arrays, each array comprising a plurality of serially connected LEDs.

5. The solar lantern of claim 1 further including a switch for controlling the power applied to said LEDs.

6. The solar lantern of claim 5 further including first and second visual indicators, said first visual indicator being illuminated when the battery charge is normal, said second visual indicator being illuminated when the battery charge has diminished below a predetermined level.

7. The solar lantern of claim 6 wherein said first and second visual indicators comprise LEDs.
